(19) United States
(12) Patent Application Publication
(10) Pub. No.: US 2017/0348901 A1
(43) Pub. Date: Dec. 7, 2017

(54) THREE-DIMENSIONAL MOLDING APPARATUS, THREE-DIMENSIONAL MOLDING METHOD, AND MOLDING MATERIAL

(71) Applicant: Konica Minolta, Inc., Chiyoda-ku, Tokyo (JP)

(72) Inventors: Akiko HARA, Tokyo (JP); Takayuki ISHIKAWA, Tokyo (JP)

(73) Assignee: Konica Minolta, Inc., Chiyoda-ku, Tokyo (JP)

(21) Appl. No.: 15/539,453

(22) PCT Filed: Nov. 16, 2015
(86) PCT No.: PCT/JP2015/082121

§ 371 Date: Jun. 23, 2017

(30) Foreign Application Priority Data
Dec. 26, 2014 (JP) 2014-265403

(51) Int. Cl. B29C 64/112; B33Y 30/00; B33Y 50/02; B29C 64/393; B29C 64/245; B33Y 70/00; B29C 64/209; B33Y 10/00; B29K 509/02; B29K 77/00; B29K 105/16

(52) U.S. Cl. CPC B29C 64/112; B29C 64/209; B33Y 30/00; B33Y 50/02; B29C 64/393; B33Y 10/00; B29C 64/245; B33Y 70/00; B29K 2077/00; B29K 2105/16; B29K 2509/02

(57) ABSTRACT

A three-dimensional molding apparatus repeatedly discharges a first molding material, which configures the surface layer of a three-dimensional molding and comprises a mechanoluminescent material that emits light upon being subjected to an external force, and a second molding material, which configures internal areas located on the inside of the surface layer of the three-dimensional molding, onto a molding stage to form a molding material layer, and molds the three-dimensional molding by layering multiple molding material layers.

### TECHNICAL FIELD

The present invention relates to a three-dimensional shaping apparatus, a three-dimensional shaping method and a shaping material.

### BACKGROUND ART

In designing of a stereoscopic shape of a product, it is important to ensure the strength of the product at the time of joining to other components, attaching to other members, contacting with external objects in use and the like. In view of this, it is necessary to confirm the strength not only by simulation, but also by producing a trial product. For example, it is difficult to determine the position and the degree of the stress acting on the trial product at the time when a trial product is mounted to an object by screwing, snapping and the like for example. Conventionally, whether the trial product can withstand the external force exerted on the trial product is confirmed by determining whether the trial product is actually broken. This results in a problem of a long time and a large cost for improvement in design of a product. If the part where the stress concentrates can be visually recognized, the part where the strength should be increased can be easily identified, and speed-up of product design can be achieved.

The following technique for visualizing the stress exerted on an object has been proposed. PTL 1 discloses a technique in which a stress-induced light-emitting material is mixed in the material of fasteners such as a washer, a nut, a bolt and the like, and a stress-induced light-emitting material is applied to the surface of the fasteners. In the technique disclosed in PTL 1, the light emission quantity of the stress-induced light-emitting material is measured when an object is clamped with use of the fastener to measure the degree of the external force exerted on a fastener.

PTL 2 discloses a technique of applying, to a surface of a structure such as a wall, a stress-induced light-emitting material which emits light when a strain energy is applied thereto and emits light with the light emission quantity in accordance with the degree of the variation of the strain energy density. In the technique disclosed in PTL 2, light emission from an stress-induced light-emitting material is detected with use of an imaging means (camera) and the like in a state where strain variation is caused in a structure, and thus defects located on the inside and/or the rear surface of the structure which cannot be visually recognized from the surface side of the structure are detected.

### CITATION LIST

### Patent Literature

### PTL 1

Japanese Patent Application Laid-Open No. 2010-72006

### PTL 2

Japanese Patent Application Laid-Open No. 2009-92644

### SUMMARY OF INVENTION

### Technical Problem

However, the method disclosed in PTL 1 in which a stress-induced light-emitting material is mixed in a material of the three-dimensional article is disadvantageous in terms of cost since a large amount of expensive stress-induced light-emitting material is used, and is disadvantageously brittle since the three-dimensional article includes stress-induced light-emitting material. In addition, to accurately measure the external force exerted on a three-dimensional article by applying a stress-induced light-emitting material to the surface of a three-dimensional article based on the techniques discloses PTLS 1 and 2, the stress-induced light-emitting material is required to be uniformly applied to the surface of the three-dimensional article. For example, in the case where a stress-induced light-emitting material is applied to the surface of a three-dimensional article by dipping (immersion), the stress-induced light-emitting material can be easily uniformly applied when the shape of the three-dimensional article is simple (for example, flat shape), but when the three-dimensional article has a sloping shape, a complicated shape and the like, it is difficult to uniformly apply the stress-induced light-emitting material to the surface of the three-dimensional article. When the stress-induced light-emitting material cannot be uniformly applied to the surface of the three-dimensional article, that is, when application unevenness is caused, the light emission quantity at a portion where the thickness of the layer of the stress-induced light-emitting material is large is greater than the light emission quantity corresponding to the actually exerted external force, and consequently the degree of the external force exerted on the three-dimensional object cannot be accurately measured, for example.

An object of the present invention is to provide a three-dimensional shaping apparatus, a three-dimensional shaping method and a shaping material which can accurately measure the degree of an external force exerted on a three-dimensional object even when the three-dimensional object has a complicated shape.

### Solution to Problem

A three-dimensional shaping apparatus according to an embodiment of the present invention includes: a shaping stage; a first ink-jet head configured to form a first model region of a shaping material layer by discharging toward the shaping stage a first shaping material which composes a surface layer part of a three-dimensional object and includes a stress-induced light-emitting material which emits light when an external force is exerted thereto; a second ink-jet head configured to form a second model region of a shaping material layer by discharging toward the shaping stage a second shaping material which composes an inner part located inside the surface layer part of the three-dimensional object; a supporting mechanism configured to support the shaping stage or the first and second ink-jet heads or both such that a relative distance between the shaping stage and the first and second ink-jet heads is variable; and a control section configured to control the first and second ink-jet heads and the supporting mechanism, repeat a process of discharging the first and second shaping materials to form a shaping material layer on the shaping stage, and stack a plurality of shaping material layers to shape a three-dimensional object.

Preferably, in the three-dimensional shaping apparatus, the first ink-jet head discharges the first shaping material having a viscosity of 5 to 15 [mPa·s].

Preferably, in the three-dimensional shaping apparatus, the first ink-jet head discharges the first shaping material including the stress-induced light-emitting material having a volume-mean particle diameter of 10 [nm] to 5 [μm].

Preferably, in the three-dimensional shaping apparatus, the first ink-jet head discharges the first shaping material in which a content of the stress-induced light-emitting material is 0.5 to 30 wt % based on a total mass of the first shaping material.

Preferably, the three-dimensional shaping apparatus further includes a third ink-jet head supported by the supporting mechanism and configured to discharge a supporting material toward the shaping stage.

Preferably, in the three-dimensional shaping apparatus further includes a fourth ink-jet head supported by the supporting mechanism and configured to discharge a fourth shaping material toward the shaping stage, the fourth shaping material including a stress-induced light-emitting material which emits light of a color different from a color of light of the stress-induced light-emitting material included in the first shaping material.

Preferably, in the three-dimensional shaping apparatus, a plurality of the first model regions including stress-induced light-emitting materials whose emission colors are different from each other are formed on a surface layer part of a three-dimensional object by selectively discharging the first shaping material and the fourth shaping material from the first ink-jet head and the fourth ink-jet head.

A three-dimensional shaping method according to an embodiment of the present invention includes: forming a first model region of a shaping material layer by discharging from a first ink-jet head toward the shaping stage a first shaping material which composes a surface layer part of a three-dimensional object and includes a stress-induced light-emitting material which emits light when an external force is exerted thereto; forming a second model region of a shaping material layer by discharging from a second ink-jet head toward the shaping stage a second shaping material which composes an inner part located inside the surface layer part of the three-dimensional object; and shaping a three-dimensional object by discharging the first and second shaping materials and stacking a plurality of shaping material layers on the shaping stage.

Preferably, in the three-dimensional shaping method, on a basis of 3D data for a configuration in which a region corresponding to a predetermined thickness from a surface of the three-dimensional object is a surface layer including the stress-induced light-emitting material, the first and second shaping materials are discharged from the first and second ink-jet heads and the plurality of shaping material layers are stacked.

A shaping material according to an embodiment of the present invention is a shaping material which is discharged toward a shaping stage from an ink-jet head during a shaping operation of a three-dimensional object, the shaping material being configured to compose a surface layer part of the three-dimensional object, and the shaping material includes a stress-induced light-emitting material which emits light when an external force is exerted thereto; and an energy curable material which is cured when an energy is applied thereto.

Preferably, in the shaping material, the stress-induced light-emitting material has a volume-mean particle diameter of 10 [nm] to 5 [μm].

Preferably, in the shaping material, a content of the stress-induced light-emitting material is 0.5 to 30 wt % based on a total mass of the shaping material.

### Advantageous Effects of Invention

According to the present invention, during a shaping operation of a three-dimensional object, a shaping material including a stress-induced light-emitting material which emits light when an external force is exerted thereto is discharged from an ink-jet head such that a surface layer part of the three-dimensional object is composed. In this manner, even when the three-dimensional object has a complicated shape, a stress-induced light-emitting material layer having a uniform thickness can be formed as the surface layer part of the three-dimensional object. As a result, regardless of the positions on the three-dimensional object where an external force exerted, the stress-induced light-emitting material layer emits light at the light emission quantity corresponding to the actually exerted stress. With this configuration, by measuring the light emission quantity, the degree of the external force exerted on the three-dimensional object can be accurately measured.

### BRIEF DESCRIPTION OF DRAWINGS

FIG. 1 schematically illustrates a configuration of a three-dimensional shaping apparatus of an embodiment;

FIG. 2 illustrates a principal part of a control system of the three-dimensional shaping apparatus of the embodiment;

FIG. 3 illustrates a configuration of a head unit of the embodiment;

FIG. 4A and FIG. 4B are schematic sectional views of a three-dimensional object obtained by a shaping operation of the three-dimensional shaping apparatus, and FIG. 4C and FIG. 4D are sectional views of a three-dimensional object shaped by a method other than ink-jet methods;

FIGS. 5A to 5C are sectional views illustrating a modification of a three-dimensional object obtained by a shaping operation of the three-dimensional shaping apparatus;

FIG. 6 illustrates a configuration of the head unit of the embodiment; and

FIGS. 7A and 7B illustrate test specimens produced in an example and a comparative example.

### DESCRIPTION OF EMBODIMENT

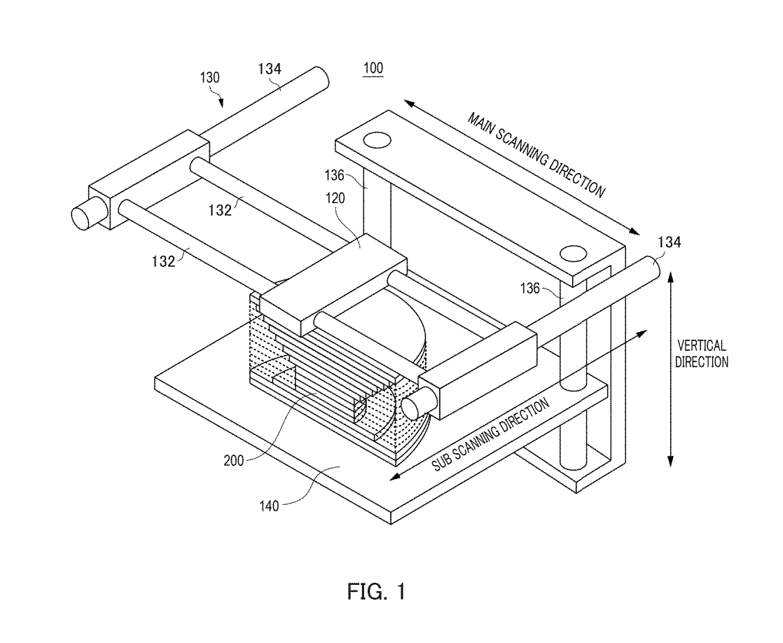

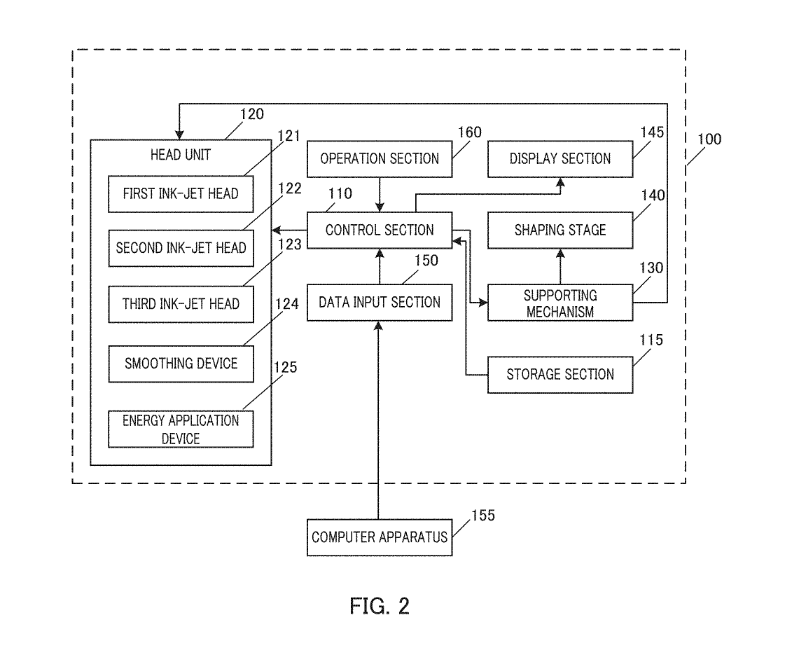

An embodiment is described below in detail with reference to the drawings. FIG. 1 schematically illustrates a configuration of three-dimensional shaping apparatus 100 according to the embodiment. FIG. 2 illustrates a principal part of a control system of three-dimensional shaping apparatus 100 according to the embodiment. In three-dimensional shaping apparatus 100 illustrated in FIGS. 1 and 2, three-dimensional object 200 is shaped by sequentially forming and stacking on shaping stage 140 a plurality of shaping material layers composed of a first model material which is a first shaping material for composing a surface layer part of three-dimensional object 200, a second model material which is a second shaping material for composing an inner part located inward of the surface layer part of three-dimensional object 200, and a supporting material which is a third shaping material for supporting the first and second model materials and making contact with the first and second model materials during an shaping operation of three-dimensional object 200. For example, in the case where the shaping object has an overhanging portion, the supporting material is provided at an outer periphery and/or an inner periphery of the first and second model materials to support the overhanging portion until the shaping of three-dimensional object 200 is completed. The supporting material is removed by the user after the shaping of three-dimensional object 200 is completed. As the first and second model materials, an energy curable material which is cured when energy such as light, heat, radiation is applied thereto is used. Energy curable materials such as photosetting resin materials and thermosetting materials have a relatively low viscosity, and it is possible to produce three-dimensional object 200 with high accuracy by discharging the material from an ink-jet head of an ink-jet type described later. In the following description of the embodiment, a photosetting material is used as a model material. In three-dimensional object 200 in FIG. 1, portions corresponding to a first model region formed with the first model material and a second model region formed with the second model material are illustrated with a solid line, and portions corresponding to a support region formed with the supporting material that supports the first and second model regions are illustrated with a broken line, for convenience of description.

Three-dimensional shaping apparatus 100 includes control section 110 configured to control each section and handle 3D data, storage section 115 configured to store various kinds of information including control programs executed by control section 110, head unit 120 for performing shaping with the first and second model materials, supporting mechanism 130 for movably supporting head unit 120, shaping stage 140 on which three-dimensional object 200 is formed, display section 145 for displaying various kinds of information, data input section 150 for exchanging various kinds of information with 3D data and the like with an external device, and operation section 160 for receiving a request of the user. Three-dimensional shaping apparatus 100 is connected to computer apparatus 155 for designing a shaping object, or for generating shaping data based on three-dimensional information obtained by measuring a real object with use of the three-dimensional measuring apparatus.

Data input section 150 receives 3D data representing the three-dimensional shape of a shaping object (such as CAD data and design data) from computer apparatus 155, and outputs the data to control section 110. The CAD data and the design data may include color image information of a part of a surface of a shaping object or the entire surface of a shaping object and color image information of the interior of a shaping object, as well as the three-dimensional shape of a shaping object. 3D data may be acquired through short-range radio communication such as wired communication, radio communication, and Bluetooth (registered trademark), or may be acquired from a recording medium such as a universal serial bus (USB) memory. In addition, the 3D data may be acquired from a server that manages and stores the 3D data, or the like.

Control section 110 includes a computing unit such as a central processing unit (CPU). Control section 110 acquires 3D data from data input section 150 and performs an analysis processing, an arithmetic processing and the like on the acquired 3D data. Control section 110 analyzes 3D data and set a region which finally composes the surface layer part of three-dimensional object 200 to the first model region, and set the region corresponding to the inner part located inside the surface layer part to the second model region. In addition, control section 110 sets the region which supports the first and second model regions and is finally removed from three-dimensional object 200 to the support region (removing region). Control section 110 sets the support region such that the amount of the supporting material to be used is as small as possible.

Control section 110 converts the 3D data acquired from data input section 150 into a multiple pieces of slice data of a shaping material layer thinly cut in the lamination direction of the shaping material layer. The slice data is shaping data of each shaping material layer for shaping three-dimensional object 200, and may be data which is created by calculating a cross-sectional shape thinly cut in the lamination direction of data of the surface of one three-dimensional object described as a collection of triangles (data of Standard Triangulated Language (STL) format). At least one of the first model region, the second model region, and the support region is set in the slice data. That is, the regions may be set in various ways. For example, the first and second model regions and the support region may be set in slice data, only the first and second model regions may be set in slice data, only the first model region and the support region may be set in slice data, and only the first model region may be set in slice data. The reason for this is that the support region and/or the surface protective layer may not be required, and that, as described above, the support region may occupy 100 [%] of the shaping material layer as a partition in a case where a plurality of shaping articles are produced in the lamination direction. The overhanging region corresponding to an overhanging portion of three-dimensional object 200 is set as the first and second model regions, and, the support region. The thickness of the slice data, that is, the thickness of the shaping material layer coincides with the distance (lamination pitch) corresponding to the thickness of one layer of shaping material layer. For example, in the case where the thickness of the shaping material layer is 0.05 [mm], control section 110 cuts out from 3D data slice data of continuous 20 sheets required for lamination of a height of 1 [mm]. It is to be noted that, the 3D data in the embodiment is configured such that a region corresponding to a given thickness from the surface of a three-dimensional object is a surface layer including a stress-induced light-emitting material described later. Here, the 3D data may be data in which a surface layer part is added to an original three-dimensional object having no surface layer part, or data which is created such that a region of a given inward thickness from the surface of an original three-dimensional object is a surface layer part. In addition, a region corresponding to a surface layer part may be included when creating slice data from 3D data.

In addition, during the shaping operation of three-dimensional object 200, control section 110 controls the entire operation of three-dimensional shaping apparatus 100. For example, mechanism control information for discharging the first and second model materials and the supporting material to a desired location is output to supporting mechanism 130, and slice data is output to head unit 120. That is, control section 110 synchronizes and controls head unit 120 and supporting mechanism 130. Control section 110 also controls energy application device 125 described later.

Under the control of control section 110, display section 145 displays various kinds of information and/or messages which should be recognized by the user. Operation section 160 includes various operation keys such as numeric keys, an execution key, a start key, receives various inputting operations by the user, and outputs an operation signal in accordance with the inputting operation to control section 110.

Shaping stage 140 is disposed below head unit 120. On shaping stage 140, shaping material layers are formed and stacked by head unit 120 so as to shape three-dimensional object 200 including the support region.

Supporting mechanism 130 supports at least one of head unit 120 and shaping stage 140 such that the relative distance between head unit 120 and shaping stage 140 is variable, and three-dimensionally changes the relative position between head unit 120 and shaping stage 140. To be more specific, as illustrated in FIG. 1, supporting mechanism 130 includes main scanning direction guide 132 that is engaged with head unit 120, sub scanning direction guide 134 that guides main scanning direction guide 132 in the sub scanning direction, and vertical direction guide 136 that guides shaping stage 140 in the vertical direction. Supporting mechanism 130 further includes a driving mechanism composed of a motor, a driving reel and the like not illustrated.

Supporting mechanism 130 drives the driving mechanism and the motor not illustrated in accordance with mechanism control information output from control section 110, and freely moves head unit 120 which serves also as a carriage in the main scanning direction and the sub scanning direction (see FIG. 1). It is to be noted that supporting mechanism 130 may have a configuration in which the position of head unit 120 is fixed and shaping stage 140 is moved in the main scanning direction and the sub scanning direction, or a configuration in which both of head unit 120 and shaping stage 140 are moved.

In addition, supporting mechanism 130 drives the driving mechanism and the motor not illustrated in accordance with mechanism control information output from control section 110, and moves shaping stage 140 downward in the vertical direction to adjust the distance between head unit 120 and three-dimensional object 200 (see FIG. 1). That is, shaping stage 140 can be vertically moved by supporting mechanism 130, and shaping stage 140 moves downward in the vertical direction by a lamination pitch after an Nth shaping material layer is formed on shaping stage 140. Here, N is a natural number. Then, after an N+1th shaping material layer is formed on shaping stage 140, shaping stage 140 again moves downward in the vertical direction again by a lamination pitch. It is to be noted that supporting mechanism 130 may have a configuration in which head unit 120 is moved upward in the vertical direction while the position of shaping stage 140 in the vertical direction is fixed, or a configuration in which both of head unit 120 and shaping stage 140 are moved.

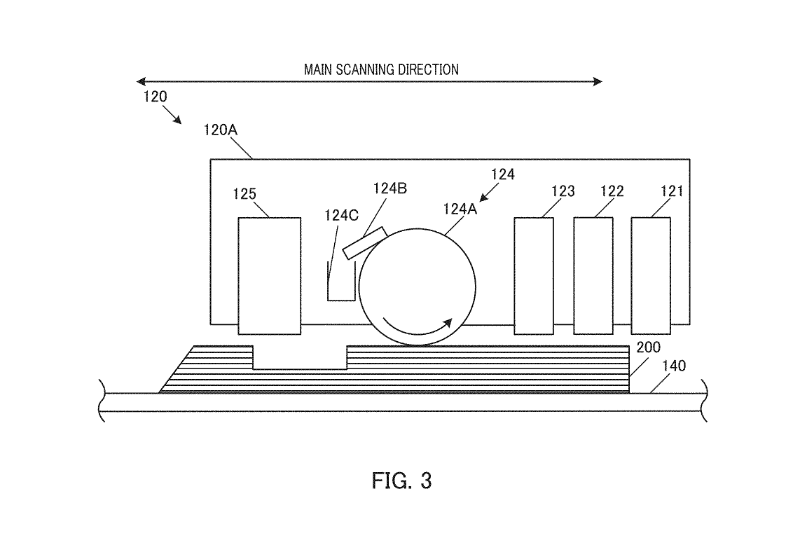

As illustrated in FIGS. 2 and 3, head unit 120 includes, internal housing 120A, first ink-jet head 121, second ink-jet head 122, third ink-jet head 123 of ink-jet type, smoothing device 124 and energy application device 125.

First ink-jet head 121 includes a plurality of discharging nozzles arranged in line in the longitudinal direction (the sub scanning direction). While the scanning in the main scanning direction orthogonal to the longitudinal direction, first ink-jet head 121 selectively discharges a droplet of the first model material from the discharging nozzles toward shaping stage 140. When forming a shaping material layer corresponding to one layer, first ink-jet head 121 discharges a droplet of the first model material to a region set to the first model region in the slice data corresponding to the shaping material layer. By repeating this discharging operation multiple times while shifting the position in the sub scanning direction, the first model region of the shaping material layer is formed in a desired region on shaping stage 140. The first model region of the shaping material layer is cured by a curing process through application of light energy. The degree of curing depends on the quantity of the light energy applied thereto, and a semi-cured state and a substantially completely cured state can be established. Here, the semi-cured state is a state where the first model material is cured by a degree lower than the complete curing such that the first model material has a viscosity enough to maintain the shape of a layer (shaping material layer).

Second ink-jet head 122 has a plurality of discharging nozzles arranged in line in the longitudinal direction (the sub scanning direction). While the scanning in the main scanning direction orthogonal to the longitudinal direction, second ink jet head 122 selectively discharges a droplet of the second model material from the discharging nozzles toward shaping stage 140. When forming a shaping material layer corresponding to one layer, second ink-jet head 122 discharges a droplet of the second model material to the region set to the second model region in the slice data corresponding to the shaping material layer. By repeating this discharging operation multiple times while shifting the position in the sub scanning direction, the second model region of the shaping material layer is formed in a desired region on shaping stage 140. The second model region of the shaping material layer is cured by a curing process through application of light energy.

Third ink-jet 123 includes a plurality of discharging nozzles arranged in line in the longitudinal direction (the sub scanning direction). While the scanning in the main scanning direction orthogonal to the longitudinal direction, third ink-jet head 123 selectively discharges a droplet of the supporting material from the discharging nozzles toward shaping stage 140. When forming a shaping material layer corresponding to one layer, third ink-jet head 123 discharges a droplet of the supporting material in a region set to the support region in the slice data corresponding to the shaping material layer. By repeating this discharging operation multiple times while shifting the position in the sub scanning direction, the support region of the shaping material layer is formed in a desired region on shaping stage 140.

As described above, supporting mechanism 130 is operated by a control signal from control section 110. Then, based on slice data sent from control section 110, the first model material is selectively supplied to shaping stage 140 from first ink-jet head 121, the second model material is selectively supplied to shaping stage 140 from second ink-jet head 122, and supporting material is selectively supplied to shaping stage 140 from third ink-jet head 123, and thus, three-dimensional object 200 is shaped. That is, with control section 110, supporting mechanism 130, head unit 120, first ink-jet head 121, second ink-jet head 122, third ink-jet head 123 and the like, a shaping material layer including at least one of the first model region, the second model region and the support region is formed.

Conventionally known ink-jet heads for image formation are used as first ink-jet head 121, second ink jet head 122 and third ink-jet head 123. It is to be noted that the plurality of discharging nozzles of first ink-jet head 121, second ink-jet head 122 and third ink-jet head 123 may be linearly disposed side by side, or linearly disposed side by side in a zigzag form as a whole as long as the nozzles are arranged in line.

The first ink-jet head 121 stores the first model material in the state where the first model material can be discharged (alternatively, the first model material is supplied from a tank not illustrated). In the embodiment, first ink-jet head 121 may be an ink jet head which can discharge the first model material having a viscosity of 5 to 15 [mPa·s], for example. It is to be noted that, in this specification, the viscosity is measured at 20° C. with a measurement device such as a capillary-type viscometer, a vibration-type viscometer, a Cannon-Fenske Viscometer, an Ostwald viscometer, and a current-type viscometer. The first model material includes a stress-induced light-emitting material which emits light when an external force (strain energy) is exerted thereto, and a photosetting material which is cured when light (light energy) of a certain wavelength is applied thereto. The stress-induced light-emitting material changes the light emission quantity in accordance with the exerted external force. The stress-induced light-emitting material is a material (ceramics) in which an element as a luminescent center is added in an inorganic crystal skeleton whose structure is highly controlled for example, which is obtained in the form of powder particles. By selecting the type of the luminescent center and/or the inorganic material, it is possible to obtain materials which emit light of various wavelengths such as ultraviolet light, visible light, and infrared light. Examples of the stress-induced light-emitting material include strontium aluminate (SrAl₂O₄:Eu) to which europium as a luminescent center for green light emission is added, zinc sulfide (ZnS:Mn) to which manganese as a luminescent center for yellow orange light emission is added and the like. In addition, examples of the stress-induced light-emitting material include the materials disclosed in Japanese Patent Application Laid-Open No. 2000-063824 and Japanese Patent Application Laid-Open No. 2000-119647.

Preferably, the volume-mean particle diameter of the stress-induced light-emitting material is 10 [nm] to 5 [μm], more preferably, 10 to 100 [nm]. When the volume-mean particle diameter of the stress-induced light-emitting material is smaller than 10 [nm], manufacturing difficulty increases, and when the volume-mean particle diameter of the stress-induced light-emitting material is greater than 5 [μm], the discharging nozzle can possibly be clogged with the stress-induced light-emitting material at the time of discharging from the discharging nozzle of third ink-jet head 123. Preferably, a content of the stress-induced light-emitting material to be added is 0.5 to 30 parts by weight (or, 0.5 to 30 wt % based on the total mass of the first model material), or more preferably 1 to 10 parts by weight based on the total mass of the first model material. The light emission quantity of the stress-induced light-emitting material at the time of reception of an external force is small when the addition amount is excessively small, whereas the strength of the first model material is sacrificed when the addition amount is excessively large. Examples of the photosetting material include ultraviolet curable resin materials, and it is possible to use radical polymerized ultraviolet curable resin materials such as acrylic acid ester and vinyl ether; and cation polymerized ultraviolet curable resin materials using a combination of an epoxy monomer, an epoxy oligomer, an oxetane monomer, an oxetane oligomer and the like, and acetophenone, benzophenone and the like as a polymerization initiator according to the resin.

Second ink-jet head 122 stores the second model material in a state where the second model material can be discharged (alternatively, the second model material is supplied from a tank not illustrated). In the embodiment, second ink-jet head 122 may be an ink-jet head which can discharge the second model material having a viscosity of 5 to 15 [mPa·s], for example. As the second model material, a photosetting material which is curable with application of light (light energy) having a certain wavelength is used. The second model material does not include the stress-induced light-emitting material.

Third ink-jet head 123 stores the supporting material in a state where the supporting material can be discharged (alternatively, the supporting material is supplied from a tank not illustrated). In the embodiment, third ink-jet head 123 may be an ink-jet head which can discharge the supporting material having a viscosity of 5 to 15 [mPa·s], for example. The supporting material includes a photosetting monomer and a light radical polymerization initiator as a photosetting material which is curable with application of light having a certain wavelength. Polyethylene glycol, partially acrylated polyol oligomer, acrylated oligomer having a hydrophilicity substituent and combinations thereof may be added to the supporting material so that a swelling property for liquid is obtained. In this manner, removal of the supporting material can be facilitated. It is to be noted that the supporting material may be a thermosetting material which is curable with application of heat energy, or a radiation curable material which is curable with application of radiation. The thermosetting material and the radiation curable material may have a water swelling property.

The shaping material is discharged from ink-jet heads 121, 122 and 123 in the form of a micro droplet (having a droplet diameter of several tens of micrometers) based on slice data of a desired three-dimensional article, and thus a high-definition shaping material layer is formed. Then, a high-definition three-dimensional object is shaped by stacking the layers. In addition, ink-jet heads 121, 122 and 123 are ink-jet heads (so-called line head) having a length which requires no sub scanning with a plurality of discharging nozzles, and can shape even a large three-dimensional object in a relatively short time.

Smoothing device 124 includes, internal housing 120A, levelling roller 124A, scraping member 124B such as a blade, and collecting member 124C. Under the control of control section 110, levelling roller 124A can be driven into rotation in the counterclockwise direction in FIG. 3, and make contact with the surface of the first and the second model materials and the surface of the supporting material discharged by first ink-jet head 121, second ink-jet head 122 and third ink-jet head 123 to smooth the irregularity of the surface of the first and second model materials, and the surface of the supporting material. As a result, a shaping material layer having a uniform layer thickness is formed. As a result of smoothing of the surface of the shaping material layer, the next shaping material layer can be precisely formed and stacked, and thus highly precise three-dimensional object 200 can be shaped. The first and second model materials and the supporting material adhered on the surface of levelling roller 124A are scraped by levelling roller 124A provided in a region near scraping member 124B. The first and second model materials, and, the supporting material scraped by scraping member 124B are collected by material collecting member 124C. It is to be noted that a rotational body, for example, an endless belt, may be used in place of levelling roller 124A.

Energy application device 125 is a light exposure head that performs a light energy application process as a curing process on the first and second model materials and the supporting material of the photosetting material discharged toward shaping stage 140 to semi-cure the materials. In the case where an ultraviolet curing material is used as the first and second model materials and the supporting material, an UV lamp which emits an ultraviolet ray (for example, high-pressure mercury lamp) is favorably used as energy application device 125. It is to be noted that instead of a high-pressure mercury lamp, a low-pressure mercury lamp, an intermediate pressure mercury lamp, an ultra-high pressure mercury lamp, a carbon-arc lamp, a metal halide lamp, a xenon lamp, an ultraviolet LED lamp or the like may be appropriately used as energy application device 125. With a control signal from control section 110, the application timing and/or the light exposure amount of energy application device 125 is controlled. The control of the light exposure amount may be performed by adjusting the voltage, the current and the like to be applied to energy application device 125 so as to change the light emission quantity of energy application device 125, or by switching or inserting an optical filter displaceable between energy application device 125 and the first and second model materials and/or the supporting material, or various kinds of switchable filters.

In this manner, with ink-jet type three-dimensional shaping apparatus 100 which can perform three-dimensional shaping with high accuracy, a shaping material layer including a region of three-dimensional object 200 and a region of a layer which is the surface layer covering three-dimensional object 200 and includes the stress-induced light-emitting material is simultaneously formed.

When forming a shaping material layer corresponding to one layer, head unit 120 discharges the first model material and the second model material to the region set to the first model region and the region set to the second model region, and the supporting material to the region set to the support region while performing scanning from one end portion to the other end portion on shaping stage 140 in the main scanning direction. Next, head unit 120 once stops the discharging of the first and second model materials and the supporting material, and performs scanning from the other end portion to one end portion on shaping stage 140 in the main scanning direction. Next, head unit 120 performs scanning in the sub scanning direction such that the position of first ink-jet head 121 for discharging the first model material, the position of second ink-jet head 122 for discharging the second model material and the position of third ink-jet head 123 for discharging the supporting material do not overlap each other. By repeating these operations, a predetermined region on shaping stage 140 can be scanned, and a shaping material layer corresponding to one layer can be formed. Three-dimensional shaping apparatus 100 sequentially forms and stacks a plurality of shaping material layers on shaping stage 140, and shapes three-dimensional object 200.

In this manner, a layer including a stress-induced light-emitting material corresponding to a surface layer covering three-dimensional object 200 which is a desired three-dimensional article can be simultaneously formed with high accuracy while forming three-dimensional object 200, and thus three-dimensional object 200 in which a uniform layer including a stress-induced light-emitting material is formed on the surface can be obtained.

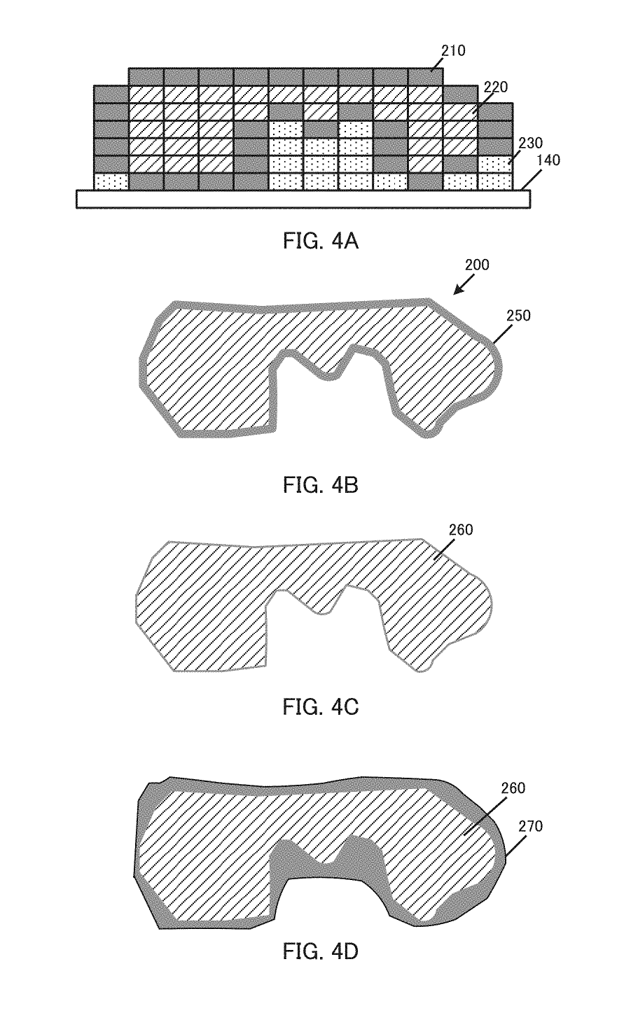

FIG. 4A is a schematic sectional view illustrating three-dimensional object 200 in a shaping operation. It is to be noted that, in FIG. 4A, for convenience of description of the shaping operation of three-dimensional shaping apparatus 100, boundary lines are provided between discharging dots and shaping material layers, and each dot is schematically illustrated in a large size. When forming shaping material layers, first ink-jet head 121 discharges a droplet of first model material 210 which emits light when an external force is exerted thereto to a region set to the first model region in the slice data corresponding to the shaping material layer, that is, a region which finally composes the surface layer part of three-dimensional object 200. When forming shaping material layers, second ink-jet head 122 discharges a droplet of second model material 220 to the second model region, that is, a region set to a region which composes an inner part located inside the surface layer part of three-dimensional object 200 in the slice data corresponding to the shaping material layer. When forming shaping material layers, third ink-jet head 123 discharges a droplet of supporting material 230 to a region set to the support region in the slice data corresponding to the shaping material layer.

FIG. 4B is a sectional view illustrating a state of three-dimensional object 200 after the shaping has been performed in the procedure described in FIG. 4A and supporting material 230 has been removed. A shaping material is discharged from ink jet heads 121, 122 and 123 to thereby highly accurately form a shaping material layer including the region of three-dimensional object 200, the region of the surface layer which covers three-dimensional object 200 and includes a stress-induced light-emitting material, and the support region based on slice data. When the above-mentioned shaping material layers are stacked, a stress-induced light-emitting material layer having a uniform thickness is formed in surface layer part 250 of three-dimensional object 200 as illustrated in FIG. 4B. Thus, when three-dimensional object 200 has a complicated shape, and an external force is exerted at a position in three-dimensional object 200, the stress-induced light-emitting material layer emits light with a light emission quantity corresponding to the actually exerted external force. With this configuration, by measuring the light emission quantity, the degree of the external force exerted on three-dimensional object 200 can be accurately measured.

FIG. 4C is a sectional view of three-dimensional object 260 shaped by a method (for example, cutting, injection molding) other than the ink-jet type three-dimensional shaping method. FIG. 4D is a sectional view illustrating a state after stress-induced light-emitting material 270 has been applied to the surface of three-dimensional object 260 illustrated in FIG. 4C. As illustrated in FIG. 4D, stress-induced light-emitting material 270 can be uniformly applied to the surface of three-dimensional object 260 at a portion having a simple shape (for example, flat portion) in three-dimensional object 260. Meanwhile, it is difficult to uniformly apply the stress-induced light-emitting material 270 to the surface of three-dimensional object 260 at a portion having a complicated shape in three-dimensional object 260. When the stress-induced light-emitting material 270 cannot be uniformly applied to the surface of three-dimensional object 260, that is, when application unevenness is caused, the light emission quantity at a portion where the thickness of the layer of stress-induced light-emitting material 270 is large is greater than the light emission quantity corresponding to the actually exerted external force, and consequently the degree of the external force exerted on three-dimensional object 260 cannot be accurately measured, for example.

As has been described in detail, three-dimensional shaping apparatus 100 of the embodiment includes: shaping stage 140; first ink-jet head 121 configured to form a first model region of a shaping material layer by discharging toward shaping stage 140 first shaping material 210 which composes a surface layer part of three-dimensional object 200 and includes a stress-induced light-emitting material which emits light when an external force is exerted thereto; second ink-jet head 122 configured to form a second model region of a shaping material layer by discharging toward shaping stage 140 a second shaping material which composes an inner part located inside the surface layer part of the three-dimensional object 200; supporting mechanism 130 configured to support shaping stage 140 or the first and second ink-jet head 122 or both such that a relative distance between shaping stage 140 and the first and second ink-jet head 122 is variable; and control section 110 configured to control the first and second ink-jet head 122 and supporting mechanism 130, repeat a process of discharging the first and second shaping materials to form a shaping material layer on shaping stage 140, and stack a plurality of shaping material layers to shape three-dimensional object 200.

With the above-mentioned configuration of the embodiment, in a shaping operation of three-dimensional object 200, first model material 210 including a stress-induced light-emitting material which emits light when an external force is exerted thereto is discharged from first ink-jet head 121 such that first model material 210 forms a surface layer part of three-dimensional object 200. In this manner, even when three-dimensional object 200 has a complicated shape, it is possible to form a stress-induced light-emitting material layer having a uniform thickness as the surface layer part of three-dimensional object 200. As a result, even when an external force is exerted on a position in three-dimensional object 200, the stress-induced light-emitting material layer emits light at a light emission quantity corresponding to the actually exerted stress. With this configuration, by measuring the light emission quantity, the degree of the external force exerted on three-dimensional object 200 can be accurately measured.

The designer and the engineer can actually touch the shaped three-dimensional object 200 to confirm the shape of the shaping object designed in three-dimensional CAD software, and can confirm the position and the degree of the stress on the mounting component at the time of mounting and the strength of the three-dimensional shape as a trial product in a designing phase. In particular, when the toughness of the resin of three-dimensional object 200 is set to a high value, the three-dimensional object 200 can be used as an actual product or a substitute of a component for confirmation of the operation.

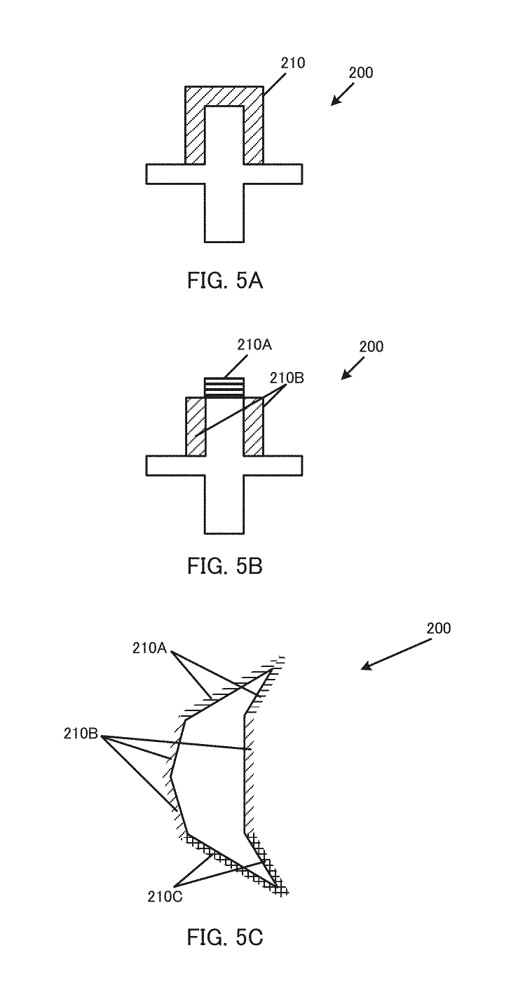

It is to be noted that, in the embodiment, it is possible to discharge first model material 210 for forming a stress-induced light-emitting material layer only at a portion where the degree of the applied external force is measured, instead of forming the stress-induced light-emitting material layer in the entirety of the surface layer part of three-dimensional object 200. For example, in FIG. 5A, stress-induced light-emitting material layer 210 is provided at only one projection part of three-dimensional object 200 having a cross shape in cross-section. In this manner, the amount of the stress-induced light-emitting material to be used can be reduced, and in turn, the cost for shaping three-dimensional object 200 can be reduced.

In addition, in the embodiment, it is also possible to form the surface layer part of three-dimensional object 200 such that the color of emitted light is changed between the main scanning direction and the sub scanning direction, and the vertical direction with use of a plurality of stress-induced light-emitting materials which emit light of respective different colors when an external force is exerted thereto. FIG. 5B illustrates a case where surface layer parts 210A and 210B of three-dimensional object 200 are formed such that the color of emitted light is changed between the main scanning direction and the sub scanning direction, and the vertical direction at one projection part of three-dimensional object 200 having a cross shape in cross-section with use of stress-induced light-emitting materials which emit light of two different colors when an external force is exerted thereto. In this manner, by measuring the light emission quantity of emission light for each color when an external force is exerted on three-dimensional object 200, the direction (the main scanning direction and the sub scanning direction, or, the vertical direction) and the degree of the external force can be readily measured.

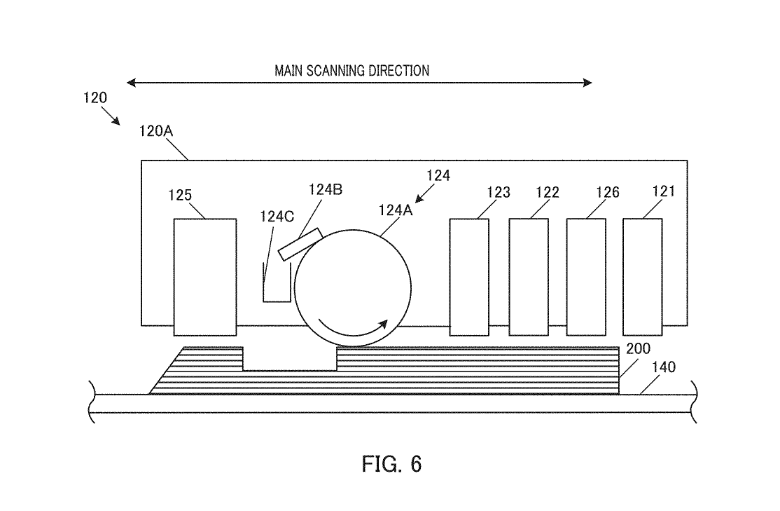

In addition, in the embodiment, it is also possible to form the surface layer part of three-dimensional object 200 such that the light emission color is changed between a plurality of different positions in a certain direction with use of a plurality of stress-induced light-emitting materials which emit light of respective different colors when an external force is exerted thereto. FIG. 5C illustrates a case where the surface layer parts 210A, 210B and 210C of three-dimensional object 200 are formed such that the color of emitted light is changed between a plurality of different positions in the vertical direction of three-dimensional object 200 having a substantially crescent shape in cross-section with use of stress-induced light-emitting materials which emit light of three different colors when an external force is exerted thereto. Here, the three stress-induced light-emitting materials are europium-added anorthite (CaAl₂Si₂O₈:Eu) which emits blue light, europium-added strontium aluminate (SrAl₂O₄:Eu) which emits green light, and manganese-added zinc sulfide (ZnS:Mn) which emits red light. In this manner, for example, by measuring the light emission quantity for each color when an external force is exerted on three-dimensional object 200 from below, it is possible to readily determine the position to which the external force is transmitted in the vertical direction. In the case where a plurality of stress-induced light-emitting materials whose emission colors are different from each other are used as described above, it is possible to use a head unit including fourth ink-jet head 126 in head unit 120 described in FIG. 2 as illustrated in FIG. 6.

While first ink-jet head 121, second ink-jet head 122 and third ink-jet head 123 and energy application device 125 are integrally provided in the embodiment, first ink-jet head 121, second ink-jet head 122 and third ink-jet head 123 and energy application device 125 may be separately provided so as to be independently moved. It should be noted that, in view of reducing the size of three-dimensional shaping apparatus 100, and suppressing the power consumption required for the movements of first ink-jet head 121, second ink-jet head 122, third ink-jet head 123, and energy application device 125, it is preferable to integrally provide first ink-jet head 121, second ink-jet head 122 and third ink-jet head 123 and energy application device 125.

It should be understood by those skilled in the art that various modifications, combinations, sub-combinations and alterations may occur depending on design requirements and other factors in so far as they are within the scope of the appended claims or the equivalents thereof. While the invention made by the present inventor has been specifically described based on the preferred embodiments, it is not intended to limit the present invention to the above-mentioned preferred embodiments but the present invention may be further modified within the scope and spirit of the invention defined by the appended claims.

### EXAMPLE EXPERIMENT

An evaluation experiment for confirming the effect of the configuration of the embodiment is described below.

### Preparation of First Model Material in Example

In Example, a first model material having the following composition was prepared by adding photopolymerization initiator (DAROCURE-TPO) to europium-added strontium aluminate (SrAl₂O₄:Eu) having a volume-mean particle diameter of 100 [nm] which is added and dispersed in dimethyl acrylic amide and trimethylol propane triacrylate.

Dimethyl acrylic amide: 84 parts by weight

Trimethylol propane triacrylate: 10 parts by weight

Europium-added strontium aluminate: 5 parts by weight

Photopolymerization initiator: 1 parts by weight

### Preparation of Second Model Material in Example

In Example, a second model material having the following composition was prepared by adding photopolymerization initiator (DAROCURE-TPO) to dimethyl acrylic amide and trimethylol propane triacrylate.

Dimethyl acrylic amide: 89 parts by weight

Trimethylol propane triacrylate: 10 parts by weight

Photopolymerization initiator: 1 parts by weight

### (Production of Test Specimen in Example

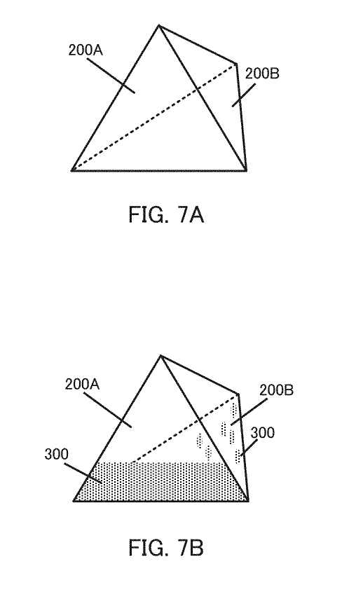

In Example, an equilateral triangular pyramid with each side of 7 [cm] (see FIG. 7A) was produced as a test specimen for evaluation with use of a three-dimensional shaping apparatus in which a plurality of ink jet heads KM512 available from Konica Minolta (standard droplet amount: 42 [pl], nozzle resolution: 360 [dpi]≈nozzle pitch: 70.5 [μm]) are mounted for the first model material and the second model material, and a shaping stage is moved at 189 [mm/s] with respect to the fixed ink-jet heads.

### Preparation of Stress Light Emission Resin in Comparative example 1

In Comparative example 1, a stress light emission resin having the following composition was prepared by adding and dispersing europium-added strontium aluminate (SrAl₂O₄:Eu) having a volume-mean particle diameter of 100 [nm] in ABS (acrylonitrile.butadiene.styrene copolymer).

ABS: 95 parts by weight

Europium-added strontium aluminate: 5 parts by weight

### Production of Test Specimen in Comparative Example 1

In Comparative example 1, a test specimen for evaluation having an equilateral triangular pyramidal shape with one side of 7 [cm] was produced by performing injection molding of a prepared stress light emission resin with use of an injection molding machine including a metal mold for forming a shaping space corresponding to an equilateral triangular pyramid with one side of 7 [cm] (see FIG. 7A).

### Preparation of Injection Molding Resin in Comparative Example 2

In Comparative example 2, ABS (acrylonitrile.butadiene.styrene copolymer) as it is was used as an injection molding resin.

### Preparation of Stress Light Emission Coating Agent in Comparative Example 2

In Comparative example 2, stress light emission coating agent having the following composition was prepared by diluting the first model material of the Example two times with ethylene glycol monobutyl ether acetate.

First model material: 50 parts by weight

Ethylene glycol monobutyl ether acetate: 50 parts by weight

### Production of Test Specimen in Comparative Example 2

In Comparative example 2, a test specimen having an equilateral triangular pyramidal shape with one side of 7 [cm] was produced by performing injection molding of ABS (acrylonitrile.butadiene.styrene copolymer) as it is with use of an injection molding machine including a metal mold for forming a shaping space corresponding to an equilateral triangular pyramid with one side of 7 [cm] (see FIG. 7A). A test specimen for evaluation was produced by dipping (immersing) the obtained test specimen having an equilateral triangular pyramidal shape to the prepared stress light emission coating agent. It is to be noted that the equilateral triangular pyramid is pulled upward at the time of the dipping.

### Experimental Method

In the evaluation experiment, given positions (10 positions) on surface A (front surface 200A in FIG. 7A) and surface B (bottom surface 200B in FIG. 7A) of the test specimens produced in Example and Comparative examples 1 and 2 were pressed with 100 [gf] with use of digital force gage FGP-0.2 available from As One Corporation. The light emission quantity at this time was measured with use of a color luminance meter available from Konica Minolta CS-200. Variations in light emission quantity (surface A and surface B) in Example and Comparative examples 1 and 2 were evaluated in accordance with the following evaluation criteria.

### Variations in Light Emission Quantity

A: the difference between the maximum value and the minimum value was smaller than 1 [%]

B: the difference between the maximum value and the minimum value was equal to or greater than 1 [%] and smaller than 5 [%]

C: the difference between the maximum value and the minimum value was equal to or greater than 5 [%]

In addition, in the evaluation experiment, the entirety of the test specimens produced in Example and Comparative examples 1 and 2 was pressed with 1,000 [gf] with use of a digital force gage FGP-0.2 available from As One Corporation. At this time, whether the test specimen was damaged (which includes cracking and breaking) was visually checked. The brittleness of the test specimens of Example and Comparative examples 1 and 2 was evaluated in accordance with the following evaluation criteria.

### Brittleness

A: the test specimen was damaged

B: the test specimen was not damaged

Table 1 shows results of the evaluation experiment in Example and Comparative examples 1 and 2.

TABLE 1

| | Variations in light | Variations in light | |
|---|---|---|---|
| | emission quantity | emission quantity | |
| | (surface A) | (surface B) | Brittleness |
| Example | A | A | A |
| Comparative | A | A | C |
| example 1 | | | |
| Comparative | B | C | A |
| example 2 | | | |

### Experiment Result

As shown in Table 1, in Example, since a stress-induced light-emitting material layer having a uniform thickness is formed as the surface layer part of a test specimen, almost no variation in light emission quantity in accordance with the pressing force (external force) was found on surface A and surface B of the test specimen. In Comparative example 1, since the entirety of the internal side of the test specimen is a stress light emission injection molding resin, almost no variation in light emission quantity in accordance with the pressing force was found on surface A and surface B of the test specimen. It should be noted that, since the amount of the stress-induced light-emitting material is large, the brittleness thereof was increased, or in other words, the production cost was increased. In Comparative example 2, since the three-dimensional article having an equilateral triangular pyramidal shape was perpendicularly pulled up for dipping of the stress light emission coating agent, unevenness in thickness of the stress-induced light-emitting material on the surface of the test specimen layer was caused, and variation in light emission quantity in accordance with the pressing force on surface A and surface B of the test specimen was caused. To be more specific, as illustrated in FIG. 7B, due to the thickness of stress-induced light-emitting material layer 300 which increases toward the lower side on surface A (front surface 200A) of the test specimen, unevenness in thickness of stress-induced light-emitting material layer 300 on the entirety of surface B (bottom surface 200B) of the test specimen was caused.

This application is entitled to and claims the benefit of Japanese Patent Application No. 2014-265403 filed on Dec. 26, 2014, the disclosure of which including the specification, drawings and abstract is incorporated herein by reference in its entirety.

### REFERENCE SIGNS LIST

100 Three-dimensional shaping apparatus
110 Control section
120 Head unit (carriage)
120A Housing
121 First ink-jet head
122 Second ink-jet head
123 Third ink-jet head
124 Smoothing device
124A Levelling roller
124B Scraping member
124C Collecting member
125 Energy application device
126 Fourth ink-jet head
130 Supporting mechanism
132 Main scanning direction guide
134 Sub scanning direction guide
136 Vertical direction guide
140 Shaping stage
145 Display section
150 Data input section
155 Computer apparatus
160 Operation section
200 Three-dimensional object
200A Front surface
200B Bottom surface
210 First model material
210A, 210B, 210C, 250 Surface layer part
220 Second model material
230 Supporting material

1. A three-dimensional shaping apparatus comprising:
a shaping stage;
a first ink-jet head configured to form a first model region of a shaping material layer by discharging toward the shaping stage a first shaping material which composes a surface layer part of a three-dimensional object and includes a stress-induced light-emitting material which emits light when an external force is exerted thereto;
a second ink-jet head configured to form a second model region of a shaping material layer by discharging toward the shaping stage a second shaping material which composes an inner part located inside the surface layer part of the three-dimensional object;
a supporting mechanism configured to support the shaping stage or the first and second ink-jet heads or both such that a relative distance between the shaping stage and the first and second ink-jet heads is variable; and
a control section configured to control the first and second ink-jet heads and the supporting mechanism, repeat a process of discharging the first and second shaping materials to form a shaping material layer on the shaping stage, and stack a plurality of shaping material layers to shape a three-dimensional object.

2. The three-dimensional shaping apparatus according to claim 1, wherein the first ink-jet head discharges the first shaping material having a viscosity of 5 to 15 [mPa·s].

3. The three-dimensional shaping apparatus according to claim 1, wherein the first ink-jet head discharges the first shaping material including the stress-induced light-emitting material having a volume-mean particle diameter of 10 [nm] to 5 [μm].

4. The three-dimensional shaping apparatus according to any one of claim 1, wherein the first ink-jet head discharges the first shaping material in which a content of the stress-induced light-emitting material is 0.5 to 30 wt % based on a total mass of the first shaping material.

5. The three-dimensional shaping apparatus according to any one of claim 1 further comprising a third ink-jet head supported by the supporting mechanism and configured to discharge a supporting material toward the shaping stage.

6. The three-dimensional shaping apparatus according to any one of claim 1 further comprising a fourth ink-jet head supported by the supporting mechanism and configured to discharge a fourth shaping material toward the shaping stage, the fourth shaping material including a stress-induced light-emitting material which emits light of a color different from a color of light of the stress-induced light-emitting material included in the first shaping material.

7. The three-dimensional shaping apparatus according to claim 6, wherein a plurality of the first model regions including stress-induced light-emitting materials whose emission colors are different from each other are formed on a surface layer part of a three-dimensional object by selectively discharging the first shaping material and the fourth shaping material from the first ink-jet head and the fourth ink-jet head.

8. A three-dimensional shaping method comprising:
forming a first model region of a shaping material layer by discharging from a first ink-jet head toward the shaping stage a first shaping material which composes a surface layer part of a three-dimensional object and includes a stress-induced light-emitting material which emits light when an external force is exerted thereto;
forming a second model region of a shaping material layer by discharging from a second ink-jet head toward the shaping stage a second shaping material which composes an inner part located inside the surface layer part of the three-dimensional object; and
shaping a three-dimensional object by discharging the first and second shaping materials and stacking a plurality of shaping material layers on the shaping stage.

9. The three-dimensional shaping method according to claim 8, wherein, on a basis of 3D data for a configuration in which a region corresponding to a predetermined thickness from a surface of the three-dimensional object is a surface layer including the stress-induced light-emitting material, the first and second shaping materials are discharged from the first and second ink-jet heads and the plurality of shaping material layers are stacked.

10. A shaping material which is discharged toward a shaping stage from an ink-jet head during a shaping operation of a three-dimensional object, the shaping material being configured to compose a surface layer part of the three-dimensional object,
the shaping material comprising:
a stress-induced light-emitting material which emits light when an external force is exerted thereto; and
an energy curable material which is cured when an energy is applied thereto.

11. The shaping material according to claim 10, wherein the stress-induced light-emitting material has a volume-mean particle diameter of 10 [nm] to 5 [μm].

12. The shaping material according to claim 10, wherein a content of the stress-induced light-emitting material is 0.5 to 30 wt % based on a total mass of the shaping material.
